(19) United States
(12) Patent Application Publication
(10) Pub. No.: US 2009/0092433 A1
(43) Pub. Date: Apr. 9, 2009

(54) Shrunk keyboard for composite keys

(76) Inventor: Stephen Chen, Shengang Shiang (TW)

Correspondence Address: BRUCE H. TROXELL, SUITE 1404, 5205 LEESBURG PIKE, FALLS CHURCH, VA, 22041, US

(21) Appl. No.: 11/907,026

(22) Filed: Oct. 9, 2007

(51) Int. Cl. B41J 5/00

(52) U.S. Cl. 400/472

(57) ABSTRACT

A shrunk keyboard for composite keys includes at least a first key and a second key that have respectively a touch panel attached thereon. The first key and second key have respectively a sense control segment to control switching of character definition of a character cluster corresponding to another key. Thereby users can perform character input operation of a complete keyboard on the shrunk keyboard, and total character number can be increased.

### BACKGROUND OF THE INVENTION

1. Field of the Invention

The present invention relates to a shrunk keyboard for composite keys and particularly to a shrunk keyboard that is capable of expanding character clusters interactively through keys to allow users to perform character input of a complete keyboard on the shrunk keyboard.

2. Description of the Prior Art

Advances of computer technology have a growing impact to people's life. New types of input methods have been constantly developed and introduced (such as voice input, handwriting recognition input and the like). However the input interface that can most meet human requirements still is the computer keyboard. The conventional computer keyboard is originated from the earlier typewriter. Take into account of the size of human fingers, the key has to be formed in a sufficient size to avoid the neighboring keys from being mistakenly hit when each key depressing is made. Hence trying to shrink the computer keyboard encounters practical problems. Moreover, with the computer becomes more powerful and new functions being constantly developed, the number of keys has already much greater than the traditional typewriter, and the number is still growing.

As the number of keys grows, the size of the computer keyboard also increases. Nowadays a computer keyboard with fully loaded functions could have a size covering all the usable area of an entire office desk. Hence many office desks are designed with a dedicated keyboard drawer to hold the computer keyboard that can be drawn out when in use. Some office desks have the desk top designed in L-shape with one side to hold paper documents while other side to hold a computer keyboard. Such a practice results in waste of space.

Furthermore, as the size of the keyboard increases, in order to enable user's fingers to hit all the keys and prevent the palms from mistakenly touching other keys, users usually have to keep two palms in the air during typing. Maintain such an operation posture for a period of time easily makes the arms and fingers fatigued. Moreover, with the moving distance of the fingers increased, the operation speed becomes slower.

To remedy the aforesaid disadvantages, the Applicant has submitted a patent application No. 94143145 which integrates a plurality of keys operable by one finger into one key to reduce the number of keys. A touch panel is provided on each key that is divided into different segments to represent different characters. Hence the size of the entire keyboard can be greatly shrunk. With the finger touched the touch panel before the key is depressed, the character going to be entered can be detected in advance and displayed on a screen. Thus user does not have to lower the head to look at the keyboard to recognize in advance the character going to be entered. And the user can look at the screen more attentively. While the technique previously discussed can shrink the keyboard, and different characters can be represented by different segments formed on the touch panel, to get a smaller keyboard the size of each segment representing each character also becomes smaller. This makes typing accuracy lower, especially for the fast speed typists. On the other hand, maintaining a larger segment size contradicts the objective of shrinking the keyboard.

### SUMMARY OF THE INVENTION

Therefore it is an object of the present invention to provide a shrunk keyboard for composite keys that allows users to perform character input operation of a complete keyboard on the shrunk keyboard and increase the total number of installed characters.

Another object of the invention is to provide a shrunk keyboard for composite keys in cooperation with a screen keyboard table that is changeable with alteration of composite character definition of character clusters in the keyboard table. Hence the users can make comparison and switching as desired without printing all of the character (symbol) definitions on the keys to avoid clutter and reading difficulty.

To achieve the foregoing objects the invention includes at least a first key and a second key. The first key corresponds to a first character cluster displayed on a keyboard table on a screen and controls execution of character input of the first character cluster. The second key corresponds to a second character cluster displayed on the keyboard table on the screen and controls execution of character input of the second character cluster. The invention has the following features:

The first key includes a first button with a first touch panel located thereon, and at least one first sense control segment to control switching of character definition of the second character cluster corresponding to the second key and display simultaneously the second character cluster with a new character definition.

The second key includes a second button with a second touch panel located thereon, and at least one second sense control segment to control switching of character definition of the first character cluster corresponding to the first key and display simultaneously the first character cluster with a new character definition.

As the conventional standard computer keyboard is formed according to use experiences accumulated in years, the keyboard layout and number of characters have been standardized. The keyboard layout and number of characters of each brand are mostly the same. The characters include word letters (26 letters for English keyboard), regular punctuation marks and special symbols, numeral keys (0-9) and various function keys (F1-F12). A complete standard keyboard has about 80-110 keys. The characters in the first character cluster and the second character cluster include characters to be used for editing texts, such as word letters, symbols, punctuation marks, special symbols, numeral keys, and functional command characters (function keys of F1-F12) to control computer operations.

In one aspect, the first sense control segment of the first key corresponds to the first character cluster. If there are blank characters depressing of the first sense control segment still can switch the character definition of the second character cluster corresponding to the second key and the second character cluster with the new definition also is displayed simultaneously.

In another aspect, the second sense control segment of the second key corresponds to the second character cluster. If there are blank characters depressing of the second sense control segment still can switch the character definition of the first character cluster corresponding to the first key and the first character cluster with the new definition also is displayed simultaneously.

In yet another aspect, depressing of the first sense control segment of the first key causes execution of regular input of the corresponding character.

In yet another aspect, depressing of the second sense control segment of the second key causes execution of regular input of the corresponding character.

In yet another aspect, the touch panels of the first key and the second key are divided into a plurality of sense segments, usually twenty sense segments. Each segment corresponds to one character. The touch panels of the first key and the second key have total forty sense segments. The size of the touch panel is about 70 mm×70 mm. The two touch panels can be laid in a juxtaposed manner to mate a compact computer with 7 inches of screen. The maximum size of each sense segment is about 18 mm×14 mm.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an embodiment of the invention.

FIG. 2 is a schematic view of sense control segment layouts of the touch panels of the invention.

FIG. 3 is a schematic view of the invention showing switching of the second character cluster.

FIG. 4 is a schematic view of the invention showing switching of the first character cluster.

FIG. 5 is an operation flow chart of the invention.

FIG. 6 is anther schematic view of the invention showing switching of the second character cluster.

FIG. 7 is anther schematic view of the invention showing switching of the first character cluster.

### DESCRIPTION OF THE PREFERRED EMBODIMENTS

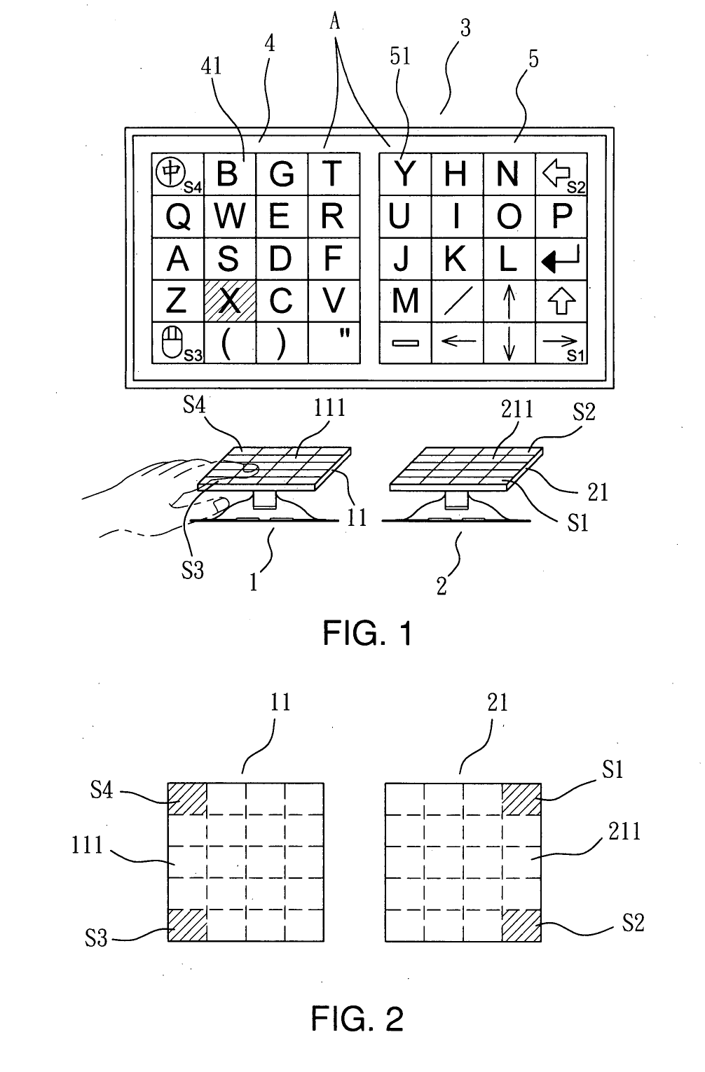

Referring to FIG. 1, the shrunk keyboard for composite keys according to the invention includes at least a first key 1 and a second key 2. The first key 1 corresponds to a first character cluster 4 displayed on a keyboard table A on a screen 3. The second key 2 corresponds to a second character cluster 5 displayed on the keyboard table A on the screen 3. The first key 1 and the second key 2 have respectively a button with a first touch panel 11 and a second touch panel 21 formed thereon that are divided into a plurality of first character sense segments 111 and second character sense segments 211, and at least one first sense control segment S3 and S4 and one second sense control segment S1 and S2 (referring to FIG. 2). The sense control segments S1, S2, S3 and S4 are preferably located at four corners of the touch panels 11 and 21, shown by shaded areas with diagonal lines to avoid mistaken touch by user's fingers. The character sense segments 111 and 211, and the sense control segments S3, S4, S1 and S2 correspond respectively to a character 41 and 51 in the first character cluster 4 and the second character cluster 5. For instance, when a user's finger touches the first character sense segment 111 corresponding to “X” of the first character cluster 4, the “X” character in the first character cluster 4 on the screen 3 is inverted in color or flicks to alert the user (referring to FIG. 1). When the user's finger depresses the first touch panel 11 input of character “X” is executed.

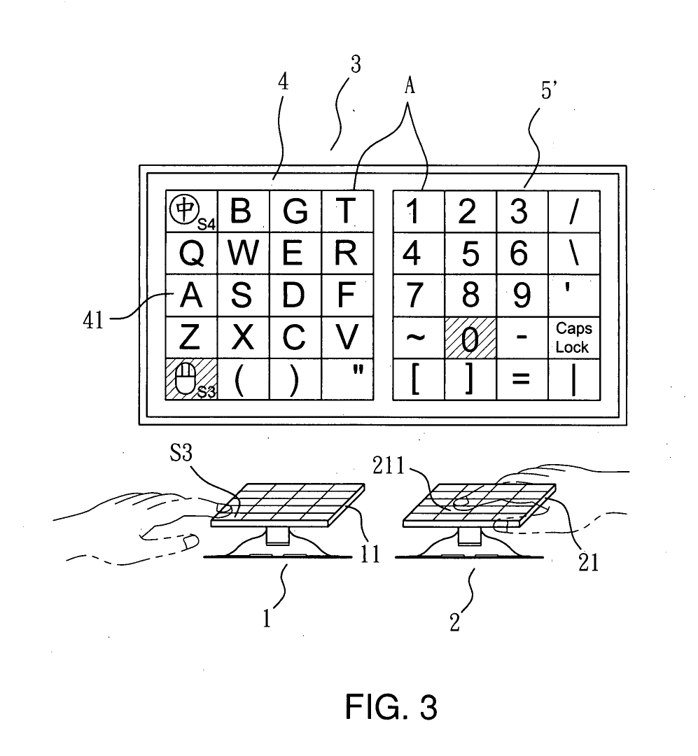

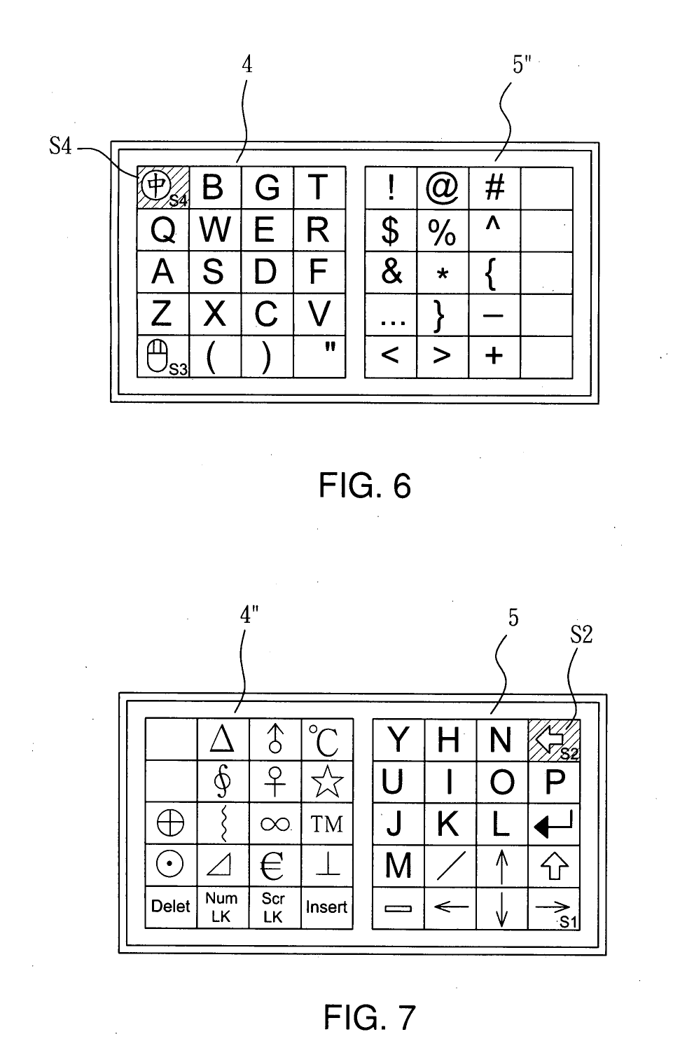

The first sense control segment S3 in the first key 1 aims to control switching of the character definition of the second character cluster 5 corresponding to the second key 2 and simultaneously display another second character cluster 5′ of a new character definition (referring to FIG. 3). For instance, when a left hand finger touches the first sense control segment S3 of the first key 1 the second character cluster 5 (shown in FIG. 1) is switched to the another second character cluster 5′ of the new character definition (switched from word characters to numeral characters, but the character definition of the first character cluster 4 remains unchanged). And the character selected by the user to be entered (such as “0”) is displayed. When the user touches the second character sense segment 211 corresponding to “0” on the second key 2 with a right finger, the “0” in the another second character cluster 5′ of the keyboard table A on the screen 3 is inverted in color (or flicks) to allow the user to do correctness confirmation. Upon confirmed, the finger depresses the second key 2 and input of the numeral “0” is executed. When a left hand finger touches another first sense control segment S4 of the first key 1, the second character cluster 5 (as shown in FIG. 1) is switched to yet another second character cluster 5″ of another new character definition as shown in FIG. 6.

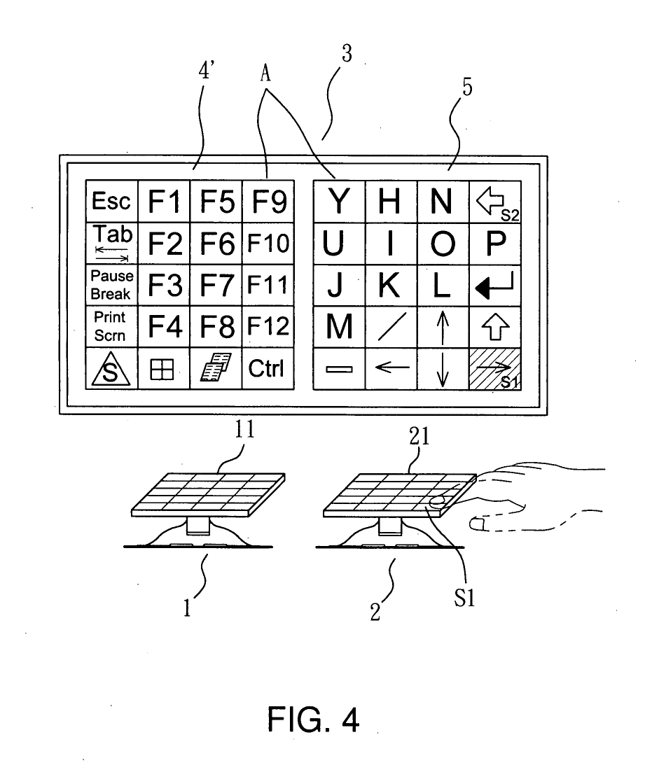

The second sense control segment S1 in the second key 2 aims to control switching of the character definition of the corresponding first character cluster 4 of the first key 1 and simultaneously display another first character cluster 4′ of a new character definition (referring to FIG. 4). For instance, when a right hand finger touches the second sense control segment S1 of the second key 2 the first character cluster 4 (shown in FIG. 1) is switched to the another first character cluster 4′ of the new character definition (switched from word characters to functional command characters for computer operations, but the character definition of the second character cluster 5 remains unchanged). And the character selected by the user to be entered is displayed. Operation is same as previously discussed. When the user touches another first sense control segment S4 of the second key 2, the first character cluster 4 (as shown in FIG. 1) is switched to yet another first character cluster 4″ of another new character definition as shown in FIG. 7.

When the sense control segments S1, S2, S3 and S4 are depressed character located thereon are entered normally. When the locations of the sense control segments S1, S2, S3 and S4 are blank characters, depressing or touching those locations alters the definition of the character cluster corresponding to another key. The character cluster of the keyboard table on the screen also is changed according to the new definition.

The first character clusters 4, 4′ and 4″ and the second character clusters 5, 5′ and 5″ previously discussed consist of various characters such as characters and word letters to be used for text editing, symbols, punctuation marks, special symbols, numeral keys and functional command characters for computer operations (such as function keys of F1-F12).

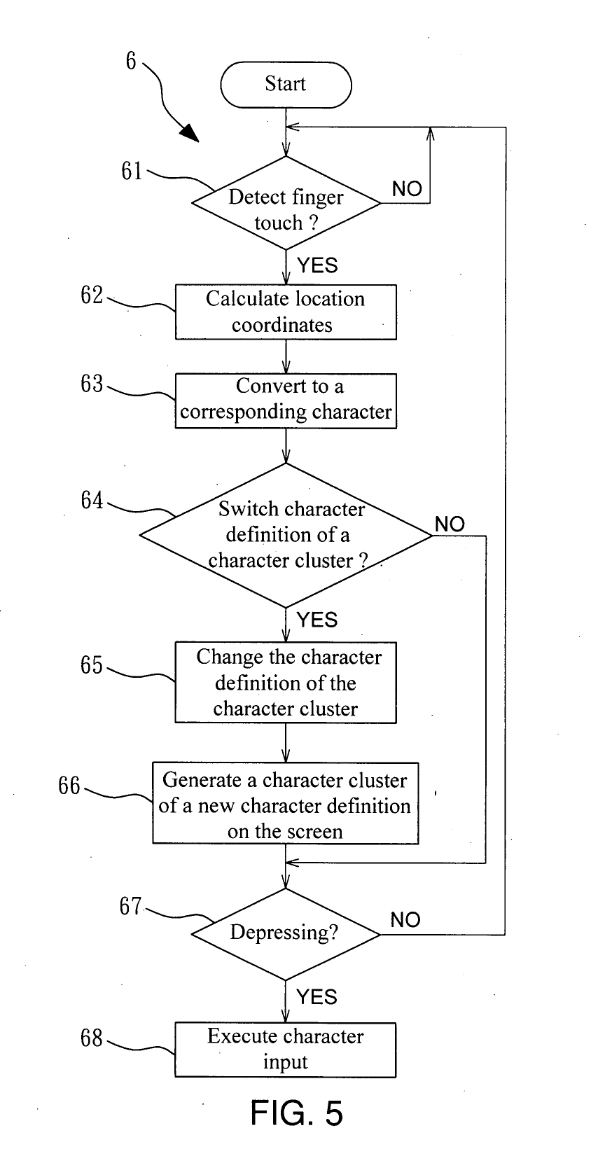

Refer to FIG. 5 for the operation flow chart to implement the invention. It includes at least the following steps (also referring to the embodiments shown in FIGS. 1, 3 and 4):

1. Detect finger touch and get coordinates to convert to a corresponding character (steps 61, 62 and 63): The touch panels 11 and 21 receive the finger touch and generate signals, and coordinates are calculated to be converted to the corresponding character;

2. Switch the character definition of a character cluster (steps 64, 65 and 66): Touch the sense control segments S1, S2, S3 and S4, and switch the character definition of the character cluster corresponding to another key; and the screen generates the character cluster of a new character definition; and

3. Select a character to be input from the character cluster according to the new character definition and depress the key (steps 67 and 68): depress the key to execute character input.

I claim:

1. A shrunk keyboard for composite keys, comprising at least a first key and a second key; the first key corresponding to a first character cluster displayed on a keyboard table on a screen and controlling input execution of characters of the first character cluster, the second key corresponding to a second character cluster displayed on the keyboard table on the screen and controlling input execution of characters of the second character cluster, wherein:
the first key includes a first button which has a first touch panel formed with at least one first sense control segment to control switching of a second character definition of the second character cluster corresponding to the second key, and simultaneously display another second character cluster that has a new second character definition; and
the second key includes a second button which has a second touch panel formed with at least one second sense control segment to control switching of a first character definition of the first character cluster corresponding to the first key, and simultaneously display another first character cluster that has a new first character definition.

2. The shrunk keyboard for composite keys of claim 1, wherein the first sense control segment is located at one of four corners of the first touch panel.

3. The shrunk keyboard for composite keys of claim 1, wherein the second sense control segment is located at one of four corners of the second touch panel.

4. The shrunk keyboard for composite keys of claim 1, wherein the first character cluster and the second character cluster include characters for editing texts.

5. The shrunk keyboard for composite keys of claim 1, wherein the first character cluster and the second character cluster include characters of functional commands to control computer operations.

6. The shrunk keyboard for composite keys of claim 1, wherein the sense control segment is depressible to execute regular input for the character at the location thereof.

7. The shrunk keyboard for composite keys of claim 1, wherein the sense control segment is at a location of a blank character, depressing or touching of the blank character causing switch to another character cluster definition corresponding to another key while another character cluster of a new definition being simultaneously displayed at the keyboard table on the screen.
